(19) United States
(12) Patent Application Publication
(10) Pub. No.: US 2025/0077248 A1
(43) Pub. Date: Mar. 6, 2025

(54) METHOD AND SYSTEM FOR AGNOSTIC-BASED END DEVICE MANAGEMENT

(71) Applicant: Verizon Patent and Licensing Inc., Basking Ridge, NJ (US)

(72) Inventors: Bharadwaj Vemuri, Jersey City, NJ (US); Namrata Prakash, Short Hills, NJ (US); Garima Garg, Livingston, NJ (US)

(21) Appl. No.: 18/457,437

(22) Filed: Aug. 29, 2023

(51) Int. Cl. G06F 9/455; G06F 9/451; H04L 67/10

(52) U.S. Cl. CPC G06F 9/455; G06F 9/452; H04L 67/10

(57) ABSTRACT

A method, a network device, and a non-transitory computer-readable storage medium are described in relation to an agnostic-based end device management service. The agnostic-based end device management service may include a network-side service that hosts persona information associated with a user and end devices. The persona information may include executable end device applications, end device application data, context information pertaining to the user and the end devices, end device application session data, and business logic. The end devices of the user may not store and execute the end device applications yet have access and use of end device functionality across varying types of end devices. The network-side service may also simulate the executable environment of an end device when providing an application service to the end device. An end device-side service of the end device may render application data and provide sensory data and input data to the network-side service.

### BACKGROUND

Development and design of networks present certain challenges from a network-side perspective and an end device perspective. Service providers, network providers, and other types of entities may manage the allocation and assignment of subscriber identification module (SIM) cards and/or other types of cards to end devices for use in accessing various networks and application services. A user may have multiple end devices that may have the same and/or different applications, data, hardware, and operating systems.

### BRIEF DESCRIPTION OF THE DRAWINGS

FIG. 1 is a diagram illustrating an exemplary environment in which an exemplary embodiment of an agnostic-based end device management service may be implemented;

FIG. 2 is a diagram illustrating an exemplary environment in which an exemplary process of an exemplary embodiment of the agnostic-based end device management service may be implemented;

FIG. 3 is a diagram illustrating another exemplary process in which an exemplary embodiment of the agnostic-based end device management service may be implemented;

FIG. 4 is a diagram illustrating exemplary components of a device that may correspond to one or more of the devices illustrated and described herein;

FIG. 5 is a flow diagram illustrating an exemplary process of an exemplary embodiment of the agnostic-based end device management service; and

FIG. 6 is a flow diagram illustrating another exemplary process of an exemplary embodiment of the agnostic-based end device management service.

### DETAILED DESCRIPTION

The following detailed description refers to the accompanying drawings. The same reference numbers in different drawings may identify the same or similar elements. Also, the following detailed description does not limit the invention.

Many users of end devices have more than one end device. For example, a user may have multiple smartphones, tablets, or another type of mobile end device. In some instances, the end devices may or may not use the same operating system (OS), hardware, applications, and/or data. As such, users may be hampered by managing their end devices given the disparities amongst them. For example, when the user wishes to switch subscriber identification module (SIM) cards and/or other types of cards between end devices, transfer or synchronize data between a new end device and an old end device, and in other similar circumstances, the user may experience difficulties in performing such managerial tasks. Additionally, a network and/or network entity (e.g., a service provider, network provider, application provider, etc.) may not offer solutions to such issues for the user. Rather, the user may be forced to fend for themselves which can be time-consuming and difficult even for technically savvy individuals.

According to exemplary embodiments, an agnostic-based end device management service is described. According to an exemplary embodiment, the agnostic-based end device management service includes a network-side service. The network-side service may include a network device that hosts persona information of a user and associated one or multiple end devices. According to an exemplary embodiment, the persona information may include executable end device applications, end device application data, context information pertaining to the user and end devices, end device application session data, and business logic, as described herein. According to an exemplary embodiment, the network-side service may use the context information (e.g., sensor data from an end device) and the business logic (e.g., which may include artificial intelligence and/or machine learning (AI/ML) logic) to provide end device application services to the user via an end device, as described herein. The network-side service may also simulate the executable environment of an end device of relevance when providing the application service to the end device. In this way, end device application session data and context may be aligned and/or in sync with the execution environment of the end device as if the end device application were executed at the end device. According to an exemplary embodiment, the user may be provided with a Uniform Resource Identifier (URI), a domain name, or the like, as described herein, that enables the user to access and use the network-side service of the agnostic-based end device management service via the end device. In this way, the user may access and use an array of end device applications regardless of which end device from among multiple end devices (e.g., which may differ in OS, form factor, hardware capabilities, etc.) the user may wish to use, as described herein.

According to an exemplary embodiment, the network device may be implemented as a virtualized device, as described herein. According to an exemplary embodiment, the network device may provide the agnostic-based end device management service for end devices that may have differing operating systems, hardware, form factors, and end device applications, for example. In this way, the end devices of the user may not store and execute the end device applications yet have access and use of end device functionality across varying types of end devices in a ubiquitous manner.

According to an exemplary embodiment, the agnostic-based end device management service may host a branded, customized, and/or themed end device application (referred to simply as a “themed end device application”). For example, the themed end device application may include a themed graphical user interface (GUI). As an example, a chat application may include themed bubbles (e.g., in terms of color, design, and/or other form of graphics) and/or other types of visuals. According to another example, the themed end device application may include a themed or novel functionality relative to a corresponding non-themed end device application (e.g., the chat application). The network-side service of the agnostic-based end device management service may enable the user to access and use such themed end device application across one or multiple end devices.

According to an exemplary embodiment, the agnostic-based end device management service includes an end device-side service. According to an exemplary embodiment, the end device-side service may include an application resident on an end device. For example, the application may be implemented to include a client application, an agent application, a web-based application, or another suitable networking application. According to an exemplary embodiment, the application may connect and provide an interface to the network device and the network-side service, as described herein. According to an exemplary embodiment, the end device-side service at the end device may include a Context Hub Runtime Environment (CHRE) that supports the application and associated components, such as an application programming interface (API) (e.g., CHRE API, sensory API, and the like) and a background, daemon, or the like type of application that may consume and render an application data stream from the network-side service at the end device. According to an exemplary embodiment, the application may provide a user interface (e.g., visual, graphical, voice, haptic, tactile, and/or the like) that enables the user to control (e.g., start, stop, interact with while executing, etc.) the end device application. According to other exemplary embodiments, the end device may not include the CHRE but may include an API (e.g., sensory API and the like) and an application or hardware that may consume and render the application data stream from the network-side service. In contrast to an end device, which may not have the capability (e.g., hardware, operating system, etc.) to execute an end device application (e.g., a thin client device or the like), the end device of the end device service may have the capability (e.g., hardware, processor, storage, OS, communication interface, etc.) to solely execute or run the (entirety of the) end device application, but instead uses the network-side service to access and use the end device application. According to other embodiments, the end device may not have the capability to solely execute the end device application, generate the application data, and render or enable a user to consume the application data, for example.

In view of the foregoing, the agnostic-based end device management service may enable users to access and use end device applications across an array of different end devices without the managerial tasks associated with each end device. In some cases, one or more of the end devices may be capable of or configured to execute one or more of the end device applications. Additionally, the agnostic-based end device management service may provide context and data synchronization for multiple end devices of a user and associated end device applications.

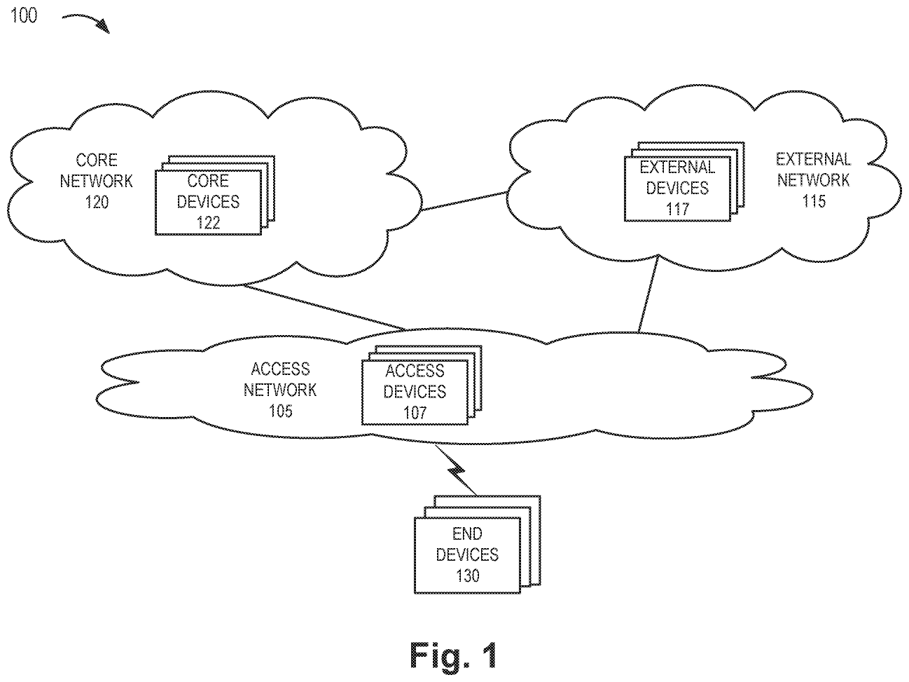

FIG. 1 is a diagram illustrating an exemplary environment 100 in which an exemplary embodiment of an agnostic-based end device management service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the agnostic-based end device management service may use at least one of these planes of communication.

Access network 105 may include one or multiple networks of one or multiple types and technologies. For example, access network 105 may be implemented to include a 5G RAN, a future generation RAN (e.g., a 6G RAN, a 7G RAN, or a subsequent generation RAN), a centralized-RAN (C-RAN), an O-RAN, and/or another type of access network. Access network 105 may include a legacy RAN (e.g., a Third Generation (3G) RAN, a Fourth Generation (4G) or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, an O-RAN network, a virtualized RAN (vRAN), a self-organizing network (SON), a wired network (e.g., optical, cable, etc.), or another type of network that provides access to or can be used as an on-ramp to access network 105.

Depending on the implementation, access network 105 may include one or multiple types of network devices, such as access devices 107. For example, access device 107 may include a next generation Node B (gNB), an evolved Long Term Evolution (eLTE) evolved Node B (eNB), an eNB, a radio network controller (RNC), a RAN intelligent controller (RIC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access customer premise equipment (FWA CPE) that provides a wireless access service.

External network 115 may include one or multiple networks of one or multiple types and technologies that provides an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

According to an exemplary embodiment, at least some of external devices 117 provide an exemplary embodiment of the network-side service of the agnostic-based end device management service, as described herein. For example, external device 117 may host persona information of a user and associated one or multiple end devices. The persona information may include executable end device applications, end device application data, application service session data, context information pertaining to the user and end devices, and business logic, as described herein. The network service may use the context information (e.g., sensor data from end device 130) and business logic (e.g., AI/ML logic) to provide end device application services to the user via end device 130.

External device 117 that provides the network service may be implemented as a virtualized device that provides the agnostic-based end device management service for end devices 130, which may have differing operating systems, hardware, form factors, end device applications, and the like, of the user. For example, external device 117 may communicate with an application (e.g., client, etc.) hosted by end device 130, as described herein. External device 117 may provide an end device application service to end device 130 based on context information included in the persona information. For example, the context information may include sensor data pertaining to the user, end device 130, and/or of a third party device. For example, the sensor data may include location data, accelerometer data, gyroscope data, magnetometer data, biometric data, radar data, proximity data, ambient light data, audio data, visual data, and/or the like that may pertain to end device 130 (e.g., a hardware sensor, a software sensor, and/or another component of end device 130), the user, and/or surrounding environment. The context information may include end device capability information that may provide a profile of end device 130. For example, end device capability information may indicate the type of end device (e.g., mobile phone versus a wristwatch, etc.), hardware and hardware capabilities (e.g., processor, memory, storage, communication interface, processing power, storage space, memory space, etc.), operating system (e.g., Android, IOS, etc.), input/output components (e.g., display, microphone, touchpad, button, speaker, keypad, etc.), attributes of the input/output components (e.g., size, functionality allocated, resolution, etc.), communication capabilities (e.g., 4G, 5G, RAT, etc.), and other relevant aspects of end device 130 that may support an end device application service session and the rendering of the end device application data to the user via end device 130. In this way, external device 117 may tailor the network service of the agnostic-based end device management service across varying end devices 130.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF) (which may include a NW-TT), a Non-3GPP Interworking Function (N3IWF), an access and mobility management function (AMF), a session management function (SMF), a unified data management (UDM) device, a unified data repository (UDR), an authentication server function (AUSF), a network slice selection function (NSSF), a network repository function (NRF), a policy control function (PCF), a network data analytics function (NWDAF), a network exposure function (NEF), a service capability exposure function (SCEF), a lifecycle management (LCM) device, a TSCTSF, a mobility management entity (MME), a packet data network gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

End device 130 includes a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, headphones, earbuds, etc.), a computer, a gaming device, a music device, or another type of wireless device (e.g., other type of user equipment (UE)). End device 130 may be configured to execute various types of software (e.g., applications, programs, etc.). The number and the types of software may vary among end devices 130. End device 130 may include “edge-aware” and/or “edge-unaware” application service clients. For purposes of description, end device 130 is not considered a network device. End device 130 may be implemented as a virtualized device in whole or in part.

End device 130 provides an exemplary embodiment of the end device-side service of the agnostic-based end device management service, as described herein. According to the end device-side service may include an application resident at end device 130. For example, the application may be implemented to include a client application, an agent application, a web-based application, and/or another suitable networking application that enables the application to connect and provide an interface to external device 117 and the network-side service, as described herein. According to an exemplary embodiment, the end device-side service at end device 130 may include a CHRE that supports the application and associated components. For example, the components may include APIs (e.g., CHRE, sensory, and the like), a nano-application, and a background, daemon, or similar application that may consume and render end device application data received from the network-side service as well as output relevant end device application data for consumption by the network-side service at external device 117. According to an exemplary embodiment, the application may provide a user interface (e.g., graphical, voice, haptic, and/or the like) that enables the user to interact with the end device application. The user interface may vary among end devices 130 depending on the type of end device (e.g., watch versus smartphone, etc.) and associated end device profile/capabilities.

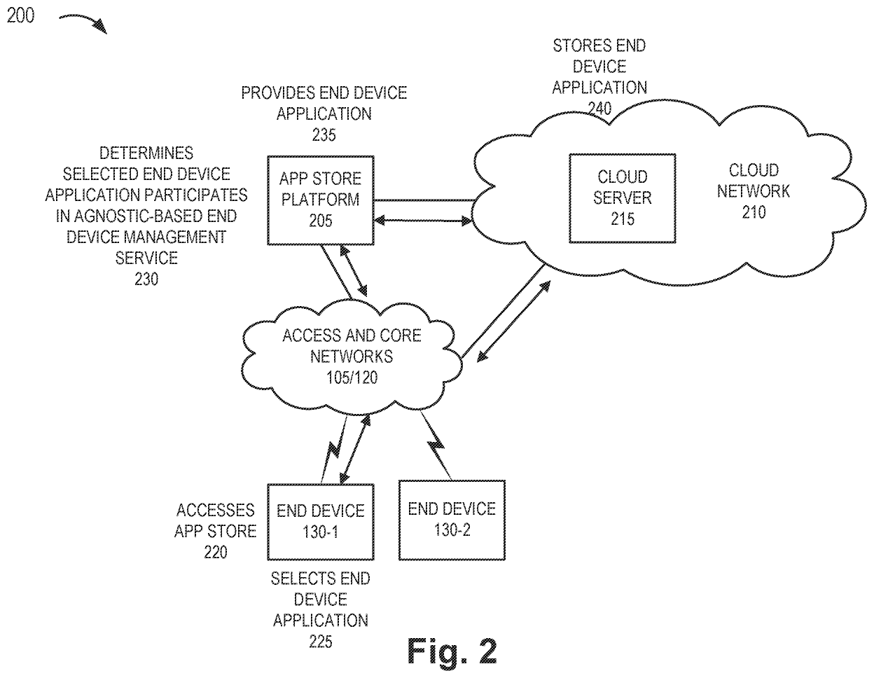

FIG. 2 is a diagram illustrating an exemplary environment 200 in which an exemplary embodiment of the agnostic-based end device management service may be implemented. As illustrated, in addition to access network 105, core network 120, and end device 130-1 and 130-2, environment 200 includes an application store platform 205 (e.g., external network 115/external device 117) and a cloud network 210 (e.g., an exemplary implementation of external network 115) and a cloud server 215 (e.g., an exemplary implementation of external device 117). According to other exemplary embodiments, environment 200 may include additional, different, and/or fewer network devices and/or networks than those depicted and described in relation to FIG. 2.

Referring to FIG. 2, application store platform 205 may include network devices that may host end device applications for download and installation by end devices 130. Application store platform 205 may also include logic that facilitates a process of the agnostic-based end device management service. For example, as described further, application store platform 205 may provide end device applications, which are hosted, to cloud server 215.

Cloud network 210 may include a network that provides access to cloud server 215. Cloud network 210 may include network devices (not shown) that provide network-related functions (e.g., security, management, charging, billing, authentication, authorization, policy enforcement, development, etc.).

Cloud server 215 may be a network device that may provide the network-side service of the agnostic-based end device management service. For example, cloud server 215 may host persona information for a user (not illustrated) of end devices 130. Cloud server 215 may be a virtualized device. According to other exemplary embodiments of the agnostic-based end device management service, cloud network 210 and/or cloud server 215 may be implemented by a different type of application service layer network, as described herein. For example, cloud network 210 and/or cloud server 215 may be implemented as a MEC network, MEC device, fog network, fog device, and/or another type of application service layer network and/or application service layer device.

According to an exemplary scenario, assume that the user (not illustrated) has end devices 130-1 and 130-2. As a part of the user's wireless subscription with a service provider, network provider, or another type of entity, the user may subscribe to the agnostic-based end device management service. For example, cloud server 215 may host persona information pertaining to the user and end devices 130. The user may be provided with a URI, a domain name, a Uniform Resource Locator (URL) and/or another type of network address to cloud server 215.

According to some exemplary embodiments, as a part of an onboarding process, cloud server 215 may be allocated to the user and configured. For example, according to some exemplary implementations, one or multiple end device applications for the user's end device 130 (e.g., a Multimedia Messaging Service (MMS) application, a contacts application, a telephone application, a camera application, etc.) that may be typically pre-installed may instead be hosted by cloud device 215. Additionally, or alternatively, one or multiple pre-installed end device applications may be resident in at least one of end device 130-1 or 130-2. As an example, end device 130-1 may store the pre-installed end device applications while end device 130-1 may access and use these pre-installed end device applications via cloud server 215.

According to an exemplary embodiment of the process of the agnostic-based end device management service, assume that end device 130-1 accesses 220 application store platform 205 via access and core networks 105/120 and selects an end device application 225 of interest. Based on the selected end device application, application store platform 205 may determine whether the selected end device application participates or is subject to the agnostic-based end device management service 230. Alternatively, when application store platform 205 may host only those end device applications that participate in or are subject to end device management service, the determination may be omitted. According to this exemplary scenario, assume that application store platform 205 may determine that the selected end device application is subject to the end device management service. In response, application store platform 205 may give the user the option to download the end device application to end device 130-1, provide the end device application to the user's cloud device 215, or both.

According to this exemplary scenario, assume that the user elects to have the end device application provided to cloud server 215. According to some exemplary embodiments, the user may provide network address information of cloud server 215 and/or other types of configuration information that enables the provisioning of the end device application at cloud server 215. According to some exemplary embodiments, sign-in information, credential information, and/or other types of information (e.g., wireless service carrier, mobile phone number, subscriber identifier, identifier for end device 130-1, etc.) may enable application store platform 205 to access information of relevance and enable the provisionment of the end device application to cloud server 215.

As illustrated, application store platform 205 may provide the selected end device application 235 to cloud server 215. Cloud server 215 may store the end device application 240. The end device application may be accessible to both end device 130-1 and end device 130-2 depending on the type of end device application, the types of end devices 130-1 and 130-2, and so forth.

FIG. 2 illustrates an exemplary process of the agnostic-based end device management service according to an exemplary scenario, however, according to other exemplary embodiment, the process may include additional, fewer, and/or different operations than those depicted and described in relation to FIG. 2.

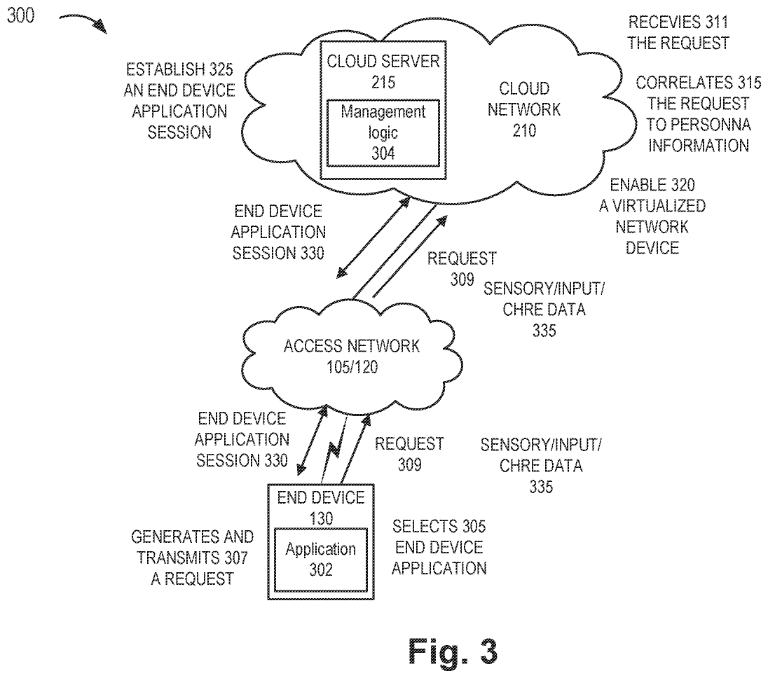

FIG. 3 is a diagram illustrating another exemplary process in which an exemplary embodiment of the agnostic-based end device management service may be implemented.

According to an exemplary scenario, a user (not illustrated) may select 305 an end device application via an application 302 of end device 130. Also assume that the user has multiple end devices 130 even though a single end device 130 is depicted in FIG. 3. As previously described, end device 130 may include logic that provides the end device-side service of the agnostic-based end device management service. As a part of the end device-side service, application 302 may permit the user to access any end device application hosted by cloud server 215 via a user interface (e.g., visual, graphical, voice, haptic, tactile, and/or the like) and control (e.g., start, stop, interact with while executing, etc.) the end device application. For example, depending on the type, capabilities, and input/output components of end device 130, application 302 may provide a desktop environment in which icons of end device applications may be presented. According to other examples, application 302 may permit the user to control the end device application by way of voice command and/or use of another form of input. For example, the user using headphones or earbud(s) may control the end device application by way of voice command. Application 302 may also render end device application data from cloud server 215 and enable the user to interact with the end device application during an end device application session with cloud server 215. Application 302 may be implemented to include a client application, an agent application, a web-based application, or another suitable networking application that may support multiple and different end device applications within a common or unified environment. The end device-side service at end device 130 may include a CHRE that supports application 302 and associated components, such as an API (e.g., CHRE API, sensory API, and the like) that may provide connectivity to and sensory/event notification and interaction with the network-side service at cloud server 215. According to other exemplary embodiments, the end device-side service may not include the CHRE, but may include a sensory API and other components that provide and support similar functionality of application 302, as described herein. The end device-side service may also support OS virtualization and an OS agnostic environment.

As further illustrated, based on the selection of the end device application via application 302, application 302 may generate and transmit 307 a request 307 to cloud server 215. A request 309 may include data that indicates an identifier of the end device application and the URI or another form of the network address of cloud server 215, which may be allocated to the user of end device 130. Request 309 may include other information, such as a unique identifier of end device 130, a network address of end device 130, sensor information (e.g., location, etc.), and so forth. According to some exemplary embodiments, in response to turning on end device 130, end device 130 may transmit request 309.

Cloud server 215 may receive 311 the request. As illustrated, cloud server 215 may include management logic 304. Management logic 304 may provide the network-side service of an exemplary embodiment of the agnostic-based end device management service. As previously described, the network-side service may host the persona information of a user and associated one or multiple end devices 130, such as end device 130 depicted in FIG. 3. The persona information may include executable end device applications, end device application data, context information pertaining to the user and end devices 130, end device application session data, and business logic. In response to receiving request 309, management logic 304 may correlate 315 information included in request 309 to the persona information. For example, management logic 304 may use one or multiple of the identifiers included in request 309 and correlate such identifier(s) to the persona information of relevance. For example, management logic 304 may determine which of end devices 130 of the user is making the request and to which one of the multiple end device applications request 309 pertains. Management logic 304 may enable or facilitate 320 a virtualized device at cloud server 215 that hosts the requested end device application in view of the determined end device 130 and its associated end device capability information, as described herein. In this way, as a part of the network-side service, the virtualized device may be configured to simulate the executable environment of end device 130. In some cases, different end devices 130 may use different versions of the same end device application depending on their end device capability information. As such, management logic 304 may account for such differences in relation to the provisionment of the virtualized network device at cloud server 215.

Management logic 304 may also use context information, which may be a part of the persona information, in provisioning and/or providing the end device application service to end device 130. For example, the context information may include sensor data of end device 130 and/or another end device 130. The context information may further include historical information pertaining to end device application use in relation to day and time, geolocation information, user preferences, and the like. As previously described, the network-side service may use the context information and the business logic (e.g., which may include AI/ML logic) to provide end device application services to the user via end device 130. The AI/ML logic may calculate predictive and/or current context information based on historical, current, and/or predictive state information associated with the user, end device 130, and/or the end device application. The AI/ML logic may include one or multiple types of models. For example, the models may include a time series model, a forecast model, a clustering model, and/or a classification model. The models may include a tree-based algorithm, a regressive algorithm, and/or another type of AI/ML algorithm or logic, such as Naïve Bayes, K-Nearest Neighbors, decision tree, Random Forest, gradient boosting, support vector machine, clustering via embedding, a dense neural network, a convolutional neural network, a recurrent neural network, and/or the like.

Based on the provisionment or instantiation of the virtualized device, cloud server 215 may establish 325 an end device application session with end device 130. Cloud server 215 may provide end device 130, as a part of the end device application session 330, with end device application data attributable to previous end device application sessions (e.g., for rendering within application 302). According to some exemplary embodiments, the end device application data may relate to end device 130 and/or another end device 130 associated with the user. In this way, the end device application session and the data provided to application 302 may stem from all use of the end device application regardless of which end device 130 the user may have accessed and used the end device application. Additionally, in view of the differences in end device capability information among multiple end devices 130 of the user, management logic 304 may account for such differences when providing the end device application data to end device 130 during the end device application session. Management logic 304 may also account for other types of data relating to the end device application, such as user preferences, and so forth, which may be applicable on a per-end device basis or across an array of different end devices 130.

Additionally, as previously described, during the end device application session, application 302 may transmit to management logic 304 sensory data, input data, CHRE data (e.g., nano-application data, etc.) 335, and/or other types of data pertaining to the user and/or end device 130. Management logic 304 may receive and provide this data to the virtualized device and associated executing end device application such that the hosted end device application may operate as if the end device application was executing at end device 130. Additionally, some or all of this data may be provided to the AI/ML logic for processing, storage to the persona information, and so forth.

As previously described, during end device application session 335, the user may interact with the end device application executing at cloud server 215 via application 302. Application 302 may provide a user interface that aligns with the end device capabilities of end device 130.

FIG. 3 illustrates an exemplary process of the agnostic-based end device management service according to an exemplary scenario, however, according to other exemplary embodiment, the process may include additional, fewer, and/or different operations than those depicted and described in relation to FIG. 3.

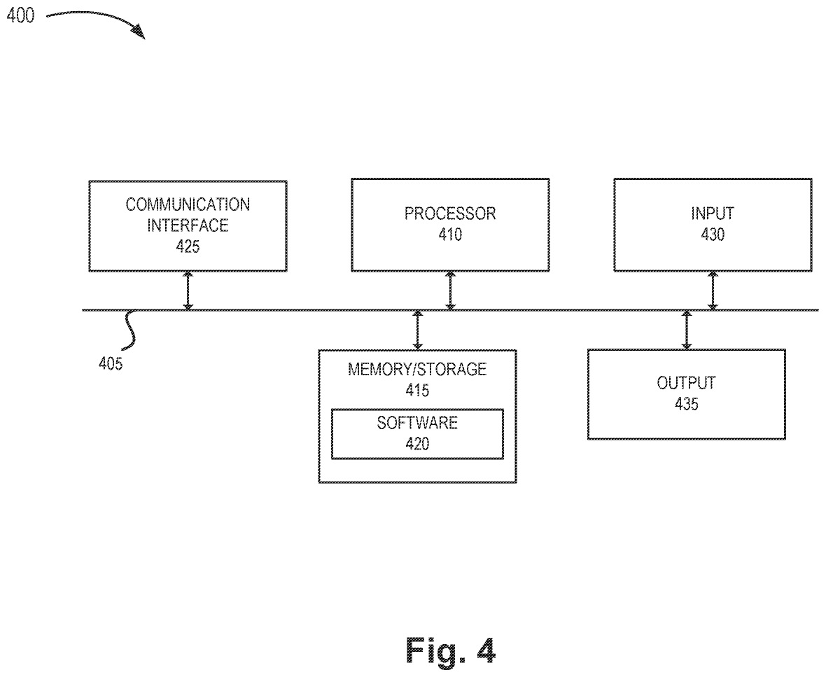

FIG. 4 is a diagram illustrating exemplary components of a device 400 that may be included in one or more of the devices described herein. For example, device 400 may correspond to access device 107, external device 117, core device 122, end device 130, cloud server 215, and/or other types of devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, learning, model-based, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, mass storage, off-line storage, or some other type of storing medium. Memory/storage 415 may store data, software, and/or instructions related to the operation of device 400.

Software 420 includes an application or a program that provides a function and/or a process. As an example, with reference to end device 130, software 420 may include an application that, when executed by processor 410, provides a function and/or a process of the end device-side service of the agnostic-based end device management service, as described herein. Additionally, for example, with reference to cloud server 215, software 420 may include an application that, when executed by processor 410, provides a function and/or a process of the network-side service of the agnostic-based end device management service, as described herein. Software 420 may also include firmware, middleware, microcode, hardware description language (HDL), and/or another form of instruction. Software 420 may also be virtualized. Software 420 may further include an operating system (OS) (e.g., Windows, Linux, Android, proprietary, etc.).

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers. Communication interface 425 may operate according to a protocol stack and a communication standard.

Input 430 permits an input into device 400. For example, input 430 may include a keyboard, a mouse, a display, a touchscreen, a touchless screen, a button, a switch, an input port, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 400 may be implemented in the same manner. For example, device 400 may be instantiated, created, deleted, or some other operational state during its life-cycle (e.g., refreshed, paused, suspended, rebooted, or another type of state or status), using well-known virtualization technologies. For example, external device 117, core device 122, external device 117, cloud server 215, and/or another type of network device or end device 130, as described herein, may be a virtualized device.

Device 400 may be configured to perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 cause processor 410 to perform a function or a process described herein. Alternatively, for example, according to other implementations, device 400 may be configured to performs a function or a process described herein based on the execution of hardware (processor 410, etc.).

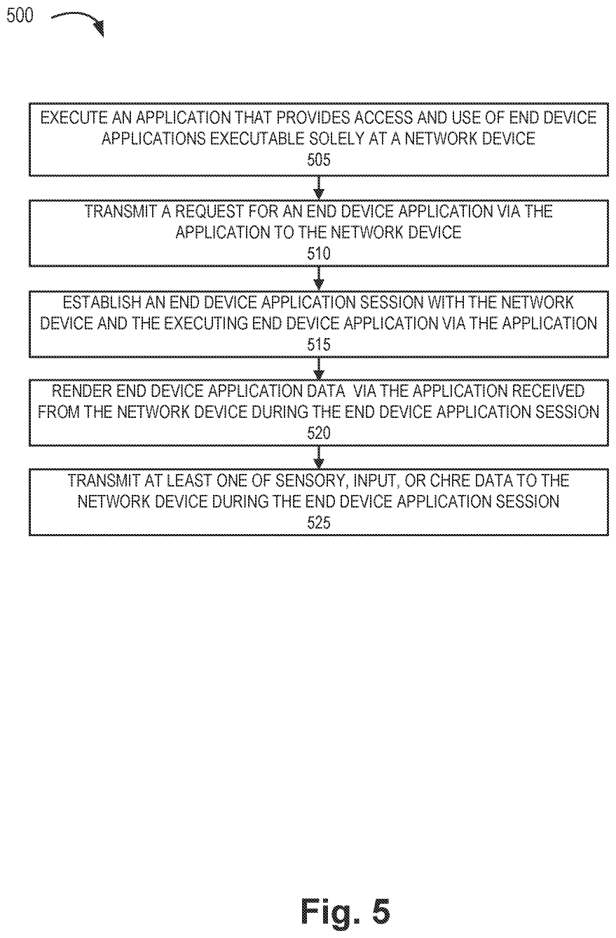

FIG. 5 is a flow diagram illustrating an exemplary process 500 of an exemplary embodiment of the agnostic-based end device management service. According to an exemplary embodiment, end device 130 may perform process 500. According to an exemplary implementation, processor 410 executes software 420 to perform a step of process 500, as described herein. Alternatively, a step may be performed by execution of only hardware.

In block 505, end device 130 may execute an application that provides access and use of end device applications executable solely at a network device. For example, the user may select an icon to initiate the execution of the application by end device 130. According to other examples, upon completion of a boot-up process of end device 130, the application may automatically execute.

In block 510, end device 130 may transmit a request for an end device application via the application to the network device. For example, end device 130 may transmit the request to cloud server 215. The request may include an identifier of end device 130. The request may include an identifier of an end device application to be executed.

In block 515, end device 130 may establish an end device application session with the network device and the executing end device application via the application.

In block 520, end device 130 may render end device application data via the application received from the network device during the end device application session.

In block 525, end device 130 may transmit at least one of sensory, input, or CHRE data to the network device during the end device application session.

FIG. 5 illustrates an exemplary process of the agnostic-based end device management service, however, according to other exemplary embodiments, the agnostic-based end device management service may perform additional operations, fewer operations, and/or different operations than those illustrated and described.

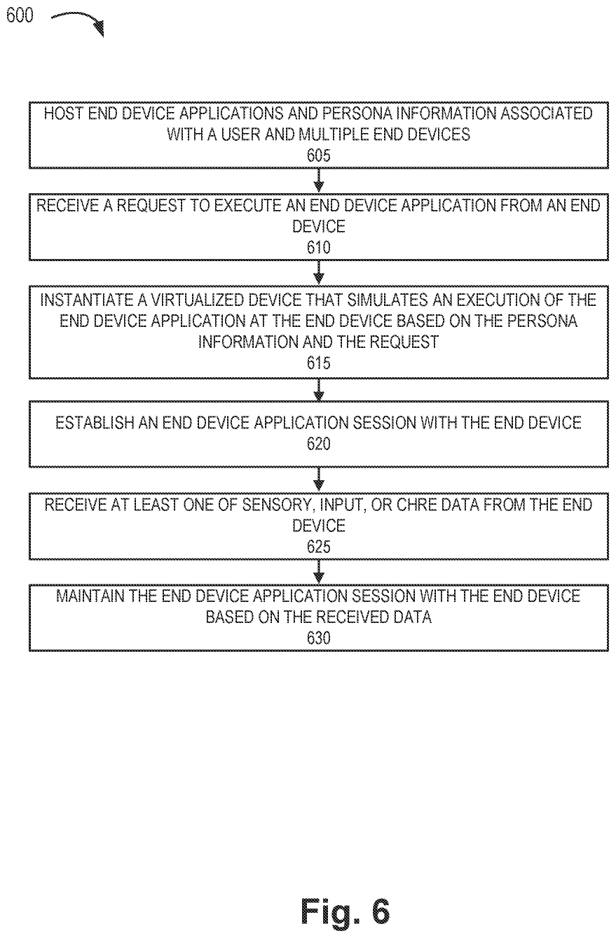

FIG. 6 is a flow diagram illustrating another exemplary process 600 of an exemplary embodiment of the agnostic-based end device management service. According to an exemplary embodiment, external device 117, such as cloud server 215 may perform process 600. According to an exemplary implementation, processor 410 executes software 420 to perform a step of process 600, as described herein. Alternatively, a step may be performed by execution of only hardware.

In block 605, external device 117 may host end device applications and persona information associated with a user and multiple end devices 130. For example, the persona information may include executable end device applications, end device application data, end device application session data, context information, end device profile and capability information, and other types of information, as described herein.

In block 610, external device 117 may receive a request to execute an end device application from end device 130. For example, the request may include a unique identifier of end device 130. The request may include an identifier for an end device application to be executed. The request may include context information.

In block 615, external device 117 may instantiate a virtualized device that simulates an execution of the end device application at end device 130 based on the persona information and the request. For example, external device 117 may correlate the unique identifier of end device 130 and/or the identifier of the end device application with other types of stored persona information. External device 117 may instantiate and configure the virtualized device based on the correlated data. External device 117 may host the virtualized device and execute the end device application in view of the persona information pertaining to end device 130.

In block 620, external device 117 may establish an end device application session with end device 130. The end device application session may include the transmission or streaming of end device application data to end device 130, which may in turn be rendered or consumed by end device 130.

In block 630, external device 117 may receive one or more of sensory, input, or CHRE data from end device 130. For example, the sensory, input, CHRE data, or other types of data (e.g., context information, etc.) may be received based on user interaction via end device 130 during the end device application session, contextual factors (e.g., mobility, day and time, turning on another end device 130 (e.g., a peripheral device, etc.)), and/or the like.

In block 635, external device 117 may maintain the end device application session with end device 130 based on the received data. For example, external device 117 may interpret the received data and sustain the end device application session in accordance therewith.

FIG. 6 illustrates an exemplary process of the agnostic-based end device management service, however, according to other exemplary embodiments, the agnostic-based end device management service may perform additional operations, fewer operations, and/or different operations than those illustrated and described.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIGS. 5 and 6, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
hosting, by a network device, persona information that includes end device applications associated with a user and end devices of the user;
receiving, by the network device from a first end device of the end devices, a request for use of a first end device application of the end device applications;
instantiating, by the network device, a virtualized device that simulates an execution environment of the first end device and the first end device application based on the persona information and the request; and
establishing, by the network device with the first end device, a first end device application session, wherein an execution of the first end device application occurs solely at the virtualized device.

2. The method of claim 1, wherein the persona information includes end device capability information that includes hardware and operating system information pertaining to the first end device.

3. The method of claim 1, further comprising:
transmitting, by the network device to the first end device during the first end device application session, a first end device application data stream of the first end device application.

4. The method of claim 1, wherein the persona information includes second end device application session information associated with a second end device application session that occurred prior to the first end device application session and between the network device and a second end device of the end devices and the first end device application.

5. The method of claim 1, further comprising:
receiving, by the network device from the first end device during the first end device application session, at least one of sensory data, input data, or context hub runtime environment (CHRE) data; and
continuing, by the network device, the execution of the first end device application based on the at least one of the sensor data, the input data, or the CHRE data.

6. The method of claim 1, wherein the end devices includes at least two of a mobile phone, a tablet, or a wearable device that are capable of executing the first end device application.

7. The method of claim 1, wherein the end device applications include two or more of a communication service application, a fitness service application, or a navigation service application.

8. The method of claim 1, wherein the network device is included in a multi-access edge computing (MEC) network.

9. A network device comprising:
a processor that is configured to:
host persona information that includes end device applications associated with a user and end devices of the user;
receive, from a first end device of the end devices, a request for use of a first end device application of the end device applications;
instantiate a virtualized device that simulates an execution environment of the first end device and the first end device application based on the persona information and the request; and
establish with the first end device, a first end device application session, wherein an execution of the first end device application occurs solely at the virtualized device.

10. The network device of claim 9, wherein the persona information includes end device capability information that includes hardware and operating system information pertaining to the first end device.

11. The network device of claim 9, wherein the processor is further configured to:
transmit to the first end device during the first end device application session, a first end device application data stream of the first end device application.

12. The network device of claim 9, wherein the persona information includes second end device application session information associated with a second end device application session that occurred prior to the first end device application session and between the network device and a second end device of the end devices and the first end device application.

13. The network device of claim 9, wherein the processor is further configured to:
receive from the first end device during the first end device application session, at least one of sensory data, input data, or context hub runtime environment (CHRE) data; and
continue the execution of the first end device application based on the at least one of the sensor data, the input data, or the CHRE data.

14. The network device of claim 9, wherein the end devices includes at least two of a mobile phone, a tablet, or a wearable device that are capable of executing the first end device application.

15. The network device of claim 9, wherein the end device applications include two or more of a communication service application, a fitness service application, or a navigation service application.

16. The network device of claim 9, wherein the network device is included in a multi-access edge computing (MEC) network.

17. A non-transitory computer-readable storage medium storing instructions executable by a processor of a network device, wherein the instructions are configured to:
host persona information that includes end device applications associated with a user and end devices of the user;
receive, from a first end device of the end devices, a request for use of a first end device application of the end device applications;
instantiate a virtualized device that simulates an execution environment of the first end device and the first end device application based on the persona information and the request; and
establish with the first end device, a first end device application session, wherein an execution of the first end device application occurs solely at the virtualized device.

18. The non-transitory computer-readable storage medium of claim 17, wherein the instructions are further configured to:
receive from the first end device during the first end device application session, at least one of sensory data, input data, or context hub runtime environment (CHRE) data; and
continue the execution of the first end device application based on the at least one of the sensor data, the input data, or the CHRE data.

19. The non-transitory computer-readable storage medium of claim 17, wherein the instructions are further configured to:
transmit to the first end device during the first end device application session, a first end device application data stream of the first end device application.

20. The non-transitory computer-readable storage medium of claim 17, wherein the persona information includes second end device application session information associated with a second end device application session that occurred prior to the first end device application session and between the network device and a second end device of the end devices and the first end device application.
